(19) United States
(12) Patent Application Publication
(10) Pub. No.: US 2002/0081002 A1
(43) Pub. Date: Jun. 27, 2002

(54) Baseball pitch-training apparatus

(76) Inventors: Keh-Yi Lee, Yunghe City (TW); I-Ming Hsu, Rueifang Jen (TW); Shin-Shou Huang, Chung Ho City (TW); Juin-Yi Wu, Banchiau City (TW); Mei-Fang Fang, Shijr City (TW); Wan-Ying Hsu, Junghe City (TW)

Correspondence Address: LOWE HAUPTMAN GOPSTEIN GILMAN & BERNER, LLP, Suite 310, 1700 Diagonal Road, Alexandria, VA, 22314, US

(21) Appl. No.: 09/766,642

(22) Filed: Jan. 23, 2001

(30) Foreign Application Priority Data
Dec. 27, 2000 (TW) 89222577

(51) Int. Cl. A63B 69/00; G06K 9/00

(52) U.S. Cl. 382/107; 473/455; 382/103

(57) ABSTRACT

A baseball pitch-training apparatus includes a first-sampling region, second-sampling region, and a microprocessor. The first sampling region further includes a plurality of vertical and horizontal sampling units respectively along the vertical direction and the horizontal direction at the front edge of the home plate. The second sampling region is located in the rear of the first sampling region and also includes a plurality of vertical and horizontal sampling units. The sampling units of the present invention are used to generate position signals of a passing ball that will be forwarded to the microprocessor for further parsing the speed and the trajectory variation of a pitched ball, and determining whether or not the ball passed a strike region.

### BACKGROUND OF THE INVENTION

(1) Field of the Invention

The invention relates to a baseball pitch-training apparatus, which can determine the position, the trajectory variation, and the speed of a baseball passing the region within/around the home base.

(2) Description of the Prior Art

In a baseball game, performance of pitchers is a major factor of deciding the outcome. Actually, the pitcher plays an important role in a baseball team. That is the reason why a baseball team usually makes much great effort to train its pitchers. Generally, the training items for pitchers include speed-ups of the pitched balls, controls of the flight trajectories of the balls, high ratio of the balls passing the strike region, and so on. Other than the typical training, a dedicated coacher of baseball-pitching is also a crucial point leading to cultivate qualified pitcher. However, a bottleneck is the deficiency of qualified pitcher coachers. It is obvious that the current ratio of pitcher coachers to pitchers is too low in the baseball industry. A critical consequence is that each pitcher can only share very little coaching time and gain few instructions from a qualified pitcher coacher. Furthermore, an experienced pitcher coacher is hardly found nowadays. Also, there is no common criteria for a coacher or an umpire to determine whether or not a pitched ball is a strike ball, especially for the ball that is pitched to pass the rim of the strike region (the imaged rectangular region that a field umpire is used to determine if the pitched ball is a strike ball). In addition, it is also difficult for most coachers to observe clearly the flight trajectory of the pitched ball passing over the home plate by human vision.

Moreover, though a speed-detecting apparatus in the market can be used to read the speed of a pitched ball, yet its testing domain is only limited to capture a pitched ball just leaving the pitcher's hand, but incapable of measuring the speed of the pitched ball flying over the home plate (the terminal speed of the pitched ball). Definitely, such the speed-detecting apparatus provides very little help to the pitcher in improving his/her pitching skill and speed. On the other hand, any person skilled in the baseball art is aware that the terminal speed of the pitched ball is more threatened to a batter than that of just leaving the pitcher. Therefore, the training upon the pitching speed shall put more emphasis on the ball speed over the home plate, not on the initial speed just leaving the pitcher. That is to say that the conventional speed-detecting apparatus is less helpful to the pitcher for enhancing his/her skill in speed-up of the ball.

Therefore, we have made some efforts to designing new equipment for helping pitchers to improve their pitching-control recently, and thereby hopefully talented pitchers can be trained more effectively.

### SUMMARY OF THE INVENTION

Accordingly, it is a primary object of the present invention to provide a baseball pitch-training apparatus, by which the position of the pitched ball passing through the home plate can be easily monitored, and then the ball can be determined whether it passes a strike region or not.

It is another object of the present invention to provide a baseball pitch-training apparatus, by which the trajectory variation of a passing ball over the home plate can be correctly measured.

It is one more objective of the present invention to provide a baseball pitch-training apparatus, by which the speed of the pitched ball over the home plate can be correctly detected.

The baseball pitch-training apparatus in accordance with the present invention comprises a first sampling region, a second sampling region, and a microprocessor. The first sampling region, formed as a first rectangular frame located at the front edge of the home plate, includes a plurality of first horizontal sampling units and a plurality of first vertical sampling units. The first sampling region is used to provide first horizontal side frames to locate the first horizontal sampling units and, on the other hand, provides first vertical side frames to locate the first vertical sampling units. By providing the first vertical and the first horizontal sampling units, the first position signal can be generated, which relates to the coordinate of the pitched ball entering the first sampling region.

Similarly, the second sampling region, formed as a second rectangular frame located in the rear of the first sampling region, further includes a plurality of second horizontal sampling units and a plurality of second vertical sampling units. The second rectangular frame is used to provide second horizontal side frames to locate the second horizontal sampling units and, on the other hand, provides second vertical side frames to locate the second vertical sampling units. By providing the second vertical and the second horizontal sampling units, the second position signal can be generated, which relates to the coordinate of the pitched ball exiting the second sampling region.

The microprocessor, which is electrically connected with the sampling units of the first and the second sampling regions. The first and the second position signals, formed respectively by the first and the second sampling regions, are processed by the internal logic circuitry of the microprocessor to determine the pitched ball speed, the ball trajectory variation, and whether or not the ball passed through a strike region over the home plate. Thereby, useful pitching data can be fed back to the pitcher for his/her further improvement in pitching.

By providing the baseball pitch-training apparatus of the present invention as well the useful data it generates, the pitcher can have a good reference for self-improvement, even without accompanying of a pitcher coacher. Therefore, the training cost can be substantially reduced and the training efficiency can be increased.

All these objects achieved by the baseball pitch-training apparatus are described below.

### BRIEF DESCRIPTION OF THE DRAWINGS

The present invention will now be specified with reference to its preferred embodiment illustrated in the drawings, in which

FIG. 1 is a schematic view of a preferred embodiment of the baseball pitch-training apparatus in accordance with the present invention;

FIG. 2 is a block diagram to illustrate the functions of connecting all the sampling units of the both sampling regions to the microprocessor in accordance with the present invention; and

FIG. 3 is a flowchart for the preferred embodiment of the baseball pitch-training apparatus in accordance with the present invention.

### DESCRIPTION OF THE PREFERRED EMBODIMENT

The invention disclosed herein is directed to a baseball pitch-training apparatus. In the following description, numerous details are set forth in order to provide a thorough understanding of the present invention. It will be appreciated by one skilled in the baseball art that variations of these specific details are possible while still achieving the results of the present invention. In other instance, well-known components are not described in detail in order not to unnecessarily obscure the present invention.

The present invention discloses a baseball pitch-training apparatus. The apparatus utilizes a plurality of sampling units to capture the position, the trajectory variation, the speed of the pitched ball and the information whether or not the pitched ball passed the strike region over the home plate, for pitcher's reference in training. Following a preferred embodiment of the baseball pitch-training apparatus is used to elucidate the present invention.

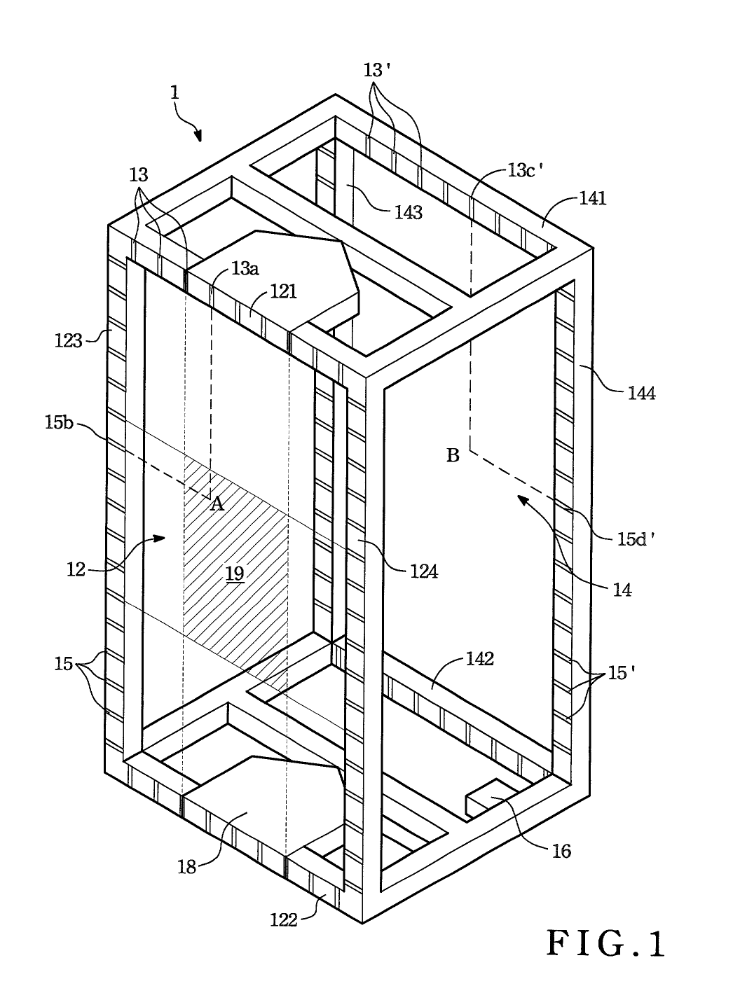

Referring now to FIG. 1, the preferred embodiment of the baseball pitch-training apparatus 1 according to the present invention is schematically shown. The apparatus 1 mainly includes a first sampling region 12, a second sampling region 14 and a microprocessor 16.

The first sampling region 12 is formed as a first rectangular frame having two first horizontal side frames 121 and 122 and two first vertical side frames 123 and 124. The first horizontal side frames 121 and 122 are used to install a plurality of first horizontal sampling units 13. On the other hand, the first vertical side frames 123 and 124 are used to install a plurality of first vertical sampling units 15. While a baseball is pitched through the first sampling region 12, the first horizontal sampling units 13 and the first vertical sampling units 15 will be triggered to generate a first position signal comprising both horizontal and vertical data of the passed ball. To achieve such a realization, any adjacent sampling unit 13 or 15 should have a spacing less than the diameter of the baseball. Also, each sampling unit 13 or 15 should include a signal emitter and a signal receiver to be respectively located at both parallel side frames. The signal emitter is used to generate a signal as a laser beam (for example, a red-light laser with a 635 nm wave-length) to be received by the corresponding signal receiver. Upon such an arrangement, a web-shape sensing surface will be formed in the first sampling region 12 after all the first vertical and horizontal sampling units 13 and 15 are turned on. Meanwhile, as a baseball is pitched through the first sampling region 12 to suddenly block penetrations of some laser beams (say position A), the sampling units 13a and 15b crossing the position A of the first sampling region 12 will be immediately interrupted and thereby to generate the first position signal including both horizontal and vertical position data of A, which relate to the coordinate of the pitched ball entering the first sampling region.

The second sampling region 14 is also formed as a second rectangular frame located in the rear of the first sampling region 12. Like the first sampling region 12, the second sampling region 14 further has two second horizontal side frames 141 and 142 and two second vertical side frames 143 and 144. The second horizontal side frames 141 and 142 are used to install a plurality of second horizontal sampling units 13′. On the other hand, the second vertical side frames 143 and 144 are used to install a plurality of second vertical sampling units 15′. Also, each sampling unit 13′ or 15′ of the second sampling region 14 should include a signal emitter and a signal receiver to be respectively located at both parallel side frames. The signal emitter is used to generate a signal as a laser beam to be received by the corresponding signal receiver. Upon such an arrangement, a web-shape sensing surface will be formed in the second sampling region 14 after all the second vertical and horizontal sampling units 13′ and 15′ are turned on. Meanwhile, as a baseball is pitched through the second sampling region 14 to suddenly block penetration of some laser beams (say position B), the sampling units 13c′ and 15d′ crossing the position B of the second sampling region 14 will be immediately interrupted and thereby to generate the second position signal including both horizontal and vertical position data of B, which relate to the coordinate of the pitched ball exiting the second sampling region.

In the present invention, the major purpose of the first sampling region 12 is to determine if the pitched ball passes a strike region over the home plate or not. Therefore, the rectangular frame forming the first sampling region 12 is preferably located at the front edge of the home plate 18. Also, before the first sampling region 12 can be constructed, the definition of the strike region 19 needs to be clarified in advance. In the present invention, the domain of the strike region 19 is an imaged small rectangular region of which its height can be electronically adjusted and selected according to the distance from a realistic batter's knee to his/her elbow. Its width is equal to that of the home plate 18. Any ball pitched through the strike region 19 is said to be a strike ball. In practice of the present invention, if and only if one of the first horizontal sampling units 13 within the domain of the strike region 19 and one of the first vertical sampling units 15 within the domain of the strike region 19 sense the pitched ball at the same time, the pitched ball can be determined to be a strike ball. Otherwise, the ball is not a strike. In this way, the first position signal, including the message of determining if or not the ball is a strike ball, can be generated and sent to a microprocessor.

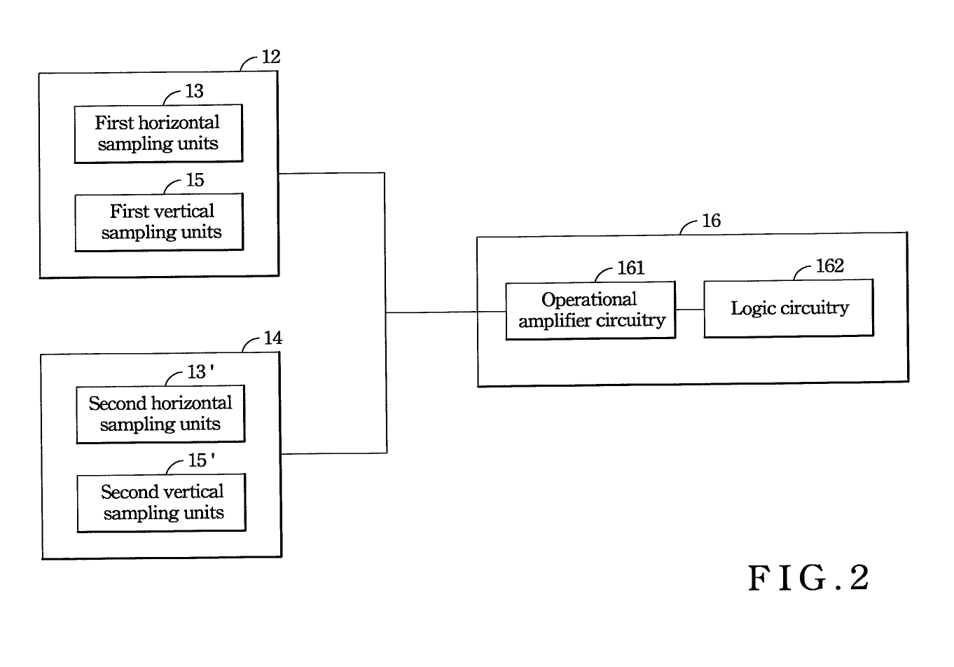

Referring now to FIG. 2, a block diagram to show the functions of connecting all the sampling units to the microprocessor 16 of the present invention is illustrated. The microprocessor 16 is mainly used to parse the first and the second position signals received respectively from the first and the second sampling regions 12 and 14. The microprocessor 16 incorporated with an operational amplifier circuitry 161 and a logic circuitry 162. The operational amplifier circuitry 161 can amplify the signals sent from the first and the second sampling regions 12 and 14, and then forward the amplified signals to the logic circuitry 162 for further parsing. In the logic circuitry 162, the ball speed, the ball trajectory variation and the strike ball or not can be determined. The ball speed can be simply derived by dividing the distance between the position coordinate of a baseball entering the first sampling regions 12 and the position coordinate of the ball exiting the second sampling regions 14 to the time duration for the ball to passing through the first and the second sampling regions 12 and 14. In addition, the microprocessor 16 can measure the ball trajectory variation through the batting area by comparing the first position signal and the second position signal. In case that the first and the second position signals are almost identical, the ball can be said to be a straight ball. If the second position signal generated by the second sampling region 14 shows the second position signal deviated from the first position signal and towards outside corners, then the ball can be said to be an outside-corner ball.

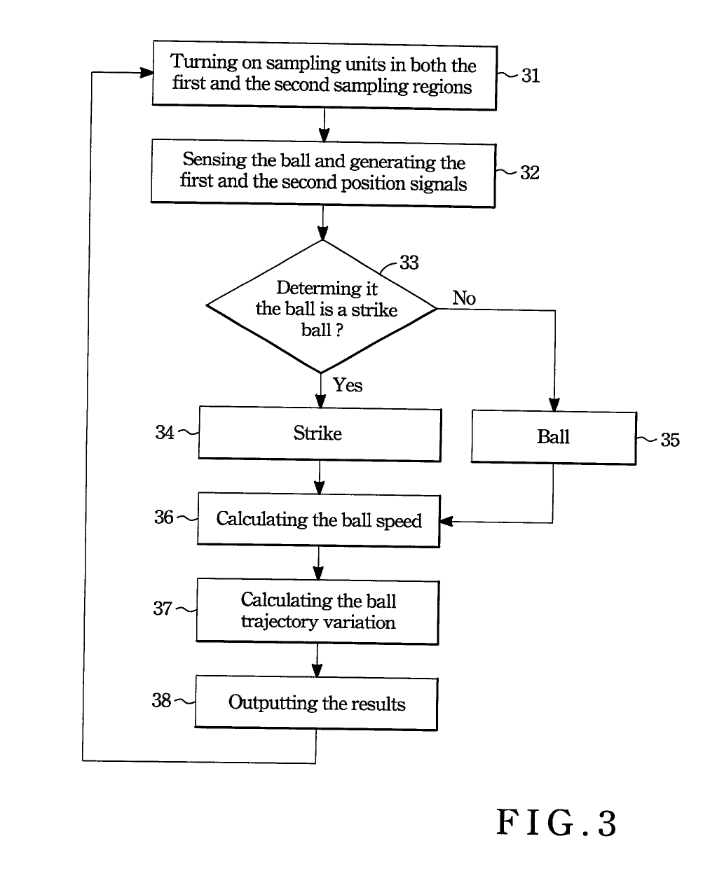

Referring now to FIG. 3, a flowchart of the baseball pitch-training apparatus is shown. Firstly (step 31), the sampling units in both the first and the second sampling regions 12 and 14 need to be turned on. Secondly (step 32), the first and the second position signals are respectively generated by the first and the second sampling regions 12 and 14 while the pitched ball passing thereupon. Then (step 33), the first position signal is used to determine if or not the pitched ball is a strike ball (step 34). Otherwise, the pitched ball is said to be a ball (step 35). In steps 36 and 37, the ball speed and the ball trajectory variation can be determined respectively by parsing the first and the second position signals. Finally in step 38, all the computation results can be output for pitcher's references.

By providing the present invention, the pitching quality, the ball trajectory, and the ball speed over the home plate can be accurately obtained, so that the pitcher can refer those data to improve his/her pitching skill. Due to the capability of the present invention to provide accurate quantified information, the baseball pitch-training apparatus herein can be used as a substitute for the role of a pitcher coacher in pitch training. Therefore, the training cost upon a pitcher can be substantially reduced, and the coaching quality of pitching can be greatly enhanced. Moreover, the baseball pitch-training apparatus in accordance with the present invention can also be used to train the umpires for regulating the human vision upon judging a strike ball.

While the present invention has been particularly shown and described with reference to a preferred embodiment, it will be understood by those skilled in the art that various changes in form and detail may be without departing from the spirit and scope of the present invention.

I claim:

1. A baseball pitch-training apparatus, comprising:
a first sampling region, further including a plurality of first horizontal sampling units and a plurality of first vertical sampling units, the first horizontal sampling units being capable of sensing a first horizontal position of a ball passing the first sampling region, and the first vertical sampling units being capable of sensing a first vertical position of the ball passing the first sampling region;
a second sampling region, located in a rear of the first sample region, further including a plurality of second horizontal sampling units and a plurality of second vertical sampling units, the second horizontal sampling units being capable of sensing a second horizontal position of the ball passing the second sampling region, and the second vertical sampling units being capable of sensing a second vertical position of the ball passing the second sampling region; and
a microprocessor, connected electrically with the first sampling region and the second sampling region, for receiving the respective position signals of the ball generated by the first sampling region and the second sampling region, for determining whether or not the ball passed a strike region, for measuring a speed of the ball, and for calculating a trajectory variation of the ball.

2. The baseball pitch-training apparatus according to claim 1, wherein said first sampling region is capable of generating a first time signal for said ball passing said first sampling region, said second sampling region is capable of generating a second time signal for said ball passing said second sampling region, and said microprocessor is capable of receiving the first time signal and the second time signal for determining said speed of said ball.

3. The baseball pitch-training apparatus according to claim 1, wherein any two adjacent said first horizontal sampling units space a distance less than a diameter of said ball, any two adjacent said first vertical sampling units space a distance less than the diameter of said ball, any two adjacent said second horizontal sampling units space a distance less than the diameter of said ball, and any two adjacent said second vertical sampling units space a distance less than the diameter of said ball.

4. The baseball pitch-training apparatus according to claim 1, wherein said first sampling region includes a first rectangular frame for providing first horizontal side frames thereof to locate said first horizontal sampling units and for providing first vertical side frames thereof to locate said first vertical sampling units.

5. The baseball pitch-training apparatus according to claim 4, wherein said first vertical sampling unit further includes a first vertical signal emitter and a respective first vertical signal receiver located thereofacross respectively at said first vertical side frames, and said first horizontal sampling unit further includes a first horizontal signal emitter and a respective first horizontal signal receiver located thereofacross respectively at said first horizontal side frames.

6. The baseball pitch-training apparatus according to claim 5, wherein said first vertical emitter and said first horizontal emitter are laser emitters.

7. The baseball pitch-training apparatus according to claim 1, wherein said second sampling region includes a second rectangular frame for providing second horizontal side frames thereof to locate said second horizontal sampling units and for providing second vertical side frames thereof to locate said second vertical sampling units.

8. The baseball pitch-training apparatus according to claim 7, wherein said second vertical sampling unit further includes a second vertical signal emitter and a respective second vertical signal receiver located thereofacross respectively at said second vertical side frames, and said second horizontal sampling unit further includes a second horizontal signal emitter and a respective second horizontal signal receiver located thereofacross respectively at said second horizontal side frames.

9. The baseball pitch-training apparatus according to claim 8, wherein said second vertical emitter and said second horizontal emitter are laser emitters.

10. The baseball pitch-training apparatus according to claim 1, wherein said microprocessor further includes a logic circuitry coupled with said first sampling region for determining whether said ball passed said strike region or not.

11. The baseball pitch-training apparatus according to claim 10, wherein said strike region is defined vertically from a knee position to an elbow position of a batter and has a width equal to that of a home plate located at said batting area.

12. The baseball pitch-training apparatus according to claim 10 further includes an operational amplifier circuitry being used to bridge said sampling units (both said vertical sampling units and said horizontal units) of said sampling regions and said logic circuitry.
